(19) United States
(12) Patent Application Publication
(10) Pub. No.: US 2018/0007069 A1
(43) Pub. Date: Jan. 4, 2018

(54) Ransomware Protection For Cloud File Storage

(71) Applicant: McAfee, Inc., Santa Clara, CA (US)

(72) Inventors: Simon Hunt, Naples, FL (US); Sean Tiernan, Santa Clara, CA (US)

(21) Appl. No.: 15/201,007

(22) Filed: Jul. 1, 2016

(51) Int. Cl. H04L 29/06

(52) U.S. Cl. CPC H04L 63/1416; H04L 63/1441

(57) ABSTRACT

A cloud storage server-based approach allows detection of ransomware activity in cloud storage systems caused by ransomware infections on an endpoint device. A heuristic or rule-based technique is employed for recognizing sequences of file operations that may indicate ransomware activity. In some embodiments, users may be offered an opportunity to approve or disapprove of the possible ransomware activity. In others, cloud system file activity may be suspended or halted for the affected user upon recognition of possible ransomware actions. Enhanced recovery of files affected prior to recognition of the ransomware activity may be performed in some embodiments.

### TECHNICAL FIELD

Embodiments described herein generally relate to cloud file storage and in particular to techniques for protecting against ransomware for cloud file storage.

### BACKGROUND ART

“Ransomware,” which is malware that encrypts user files and requires users to pay for release of the decryption key, is an increasingly successful tactic used by cybercriminals. It is effective because malware protection typically relies on identification through signature and removal of infection. Recovery of data becomes impossible in the case of a new malware variant that is not identified in time on a user's device.

Though better detection methods can be applied to endpoints such as personal computers, in the case of cloud storage systems, blind acceptance of the changes made to cloud stored data by authorized (but infected) endpoints means that an infection can propagate changes and destroy both local and cloud stored data. Users lose both their local data and cloud backups, forcing them to make a deal with cybercriminals to regain access to their personal data, pictures etc.

Since user “files” are stored as data structures within cloud services, traditional file-based protection methods are unsuitable for cloud storage environments.

### BRIEF DESCRIPTION OF DRAWINGS

FIG. 1 is a block diagram illustrating an improved system for protecting cloud storage against ransomware according to one embodiment.

FIG. 2 is a flowchart illustrating a technique for protecting cloud storage against ransomware according to one embodiment.

FIGS. 3-4 are a block diagrams illustrating programmable devices for use with techniques described herein according to two embodiments.

FIG. 5 is a block diagram illustrating a network of programmable devices according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “processing element” can refer to a single hardware processing element or a plurality of hardware processing elements that together may be programmed to perform the indicated actions. The hardware processing elements may be implemented as virtual hardware processing elements of a virtual programmable device hosted on a physical hardware device. Instructions that when executed program the processing element to perform an action may program any or all of the processing elements to perform the indicated action. Where the processing element is one or more multi-core processors, instructions that when executed program the processing element to perform an action may program any or all of the multiple cores to perform the indicated action.

As used herein, the term “malware” can refer to any software used to disrupt operation of a programmable device, gather sensitive information, or gain access to private systems or networks. Malware includes computer viruses (including worms, Trojan horses, etc.), Bots, ransomware, spyware, adware, scareware, and any other type of malicious program.

As used herein, the term “medium” can refer to a single physical medium or a plurality of media that together store the information described as being stored on the medium.

As used herein, the term “memory” can refer to a single memory device or a plurality of memory devices that together store the information described as being stored on the medium. The memory may be any type of storage device, including random access memory, read-only memory, optical and electromechanical disk drives, etc.

As used herein, the term “cloud storage” is a model of data storage in which digital data is stored in logical pools, the physical storage spans multiple servers (and often, locations), and the physical environment is typically owned and managed by a hosting company that provides services to many different entities. However, cloud storage may be provided in a private cloud, where the cloud infrastructure is operated solely for a single organization, whether managed internally or by a third party, and hosted either internally or externally to the organization. Hybrid clouds may combine private and non-private cloud resources. Cloud storage often involves mapping the cloud storage to a local drive, allowing the user to see and use the cloud storage using operating system native interfaces as if the remote cloud storage were a local drive. However, cloud storage may also interface with the user through a non-native interface, such as those provided by document management systems, that provides functionality different from a native operating system interface.

The techniques described below provide safeguards that attempt to ensure the integrity of data stored in the cloud while providing a means for recovery or protection from denial of access to that data.

A practical example of the value of these techniques is recent press re the ransomware “cryptolocker” in which claims are made that cryptolocker targeted data stored in the Google Drive™ service. (GOOGLE DRIVE is a trademark of Google, Inc.; GOOGLE is a registered trademark of Google, Inc.) In reality, the fault lies with the Google Drive replication tool (desktop Google Drive) which seamlessly replicates local file changes to the Google® cloud storage. In these cases, cryptolocker encrypts the local Google Drive folder, and Google Drive transmits those changes to the cloud, thus removing the possibility of recovering the files unless prior versions are available.

In brief, techniques described below sit in-line with the cloud file access flow (WebDAV and others) and look for transactional anomalies. Through analyzing typical user behavior, we can identify certain actions common to ransomware, and uncommon to normal user interaction. By implementing behavioral analysis of changes to cloud data storage at an application programming interface (API) level, we can identify potential “ransomware” activity and request additional authorization from users prior to committing those changes.

Identification of abnormal actions may result in the cloud service taking protective action, such as denying future changes, requiring the user to approve the changes, unwinding recent changes from a backup, etc. The detection techniques are independent of how any cloud service structures their file access I/O, by applying the techniques to the API-based access that cloud storage systems provide. One important distinction between cloud services and local storage systems is that data is typically stored by cloud storage service providers as records within a database, rather than ordinary operating system (OS) filesystem data. Current endpoint detection techniques focus on local file access and perform block-level analysis and other I/O activities. The techniques described herein move up the stack to focus on logical API-level analysis and can be implemented anywhere in the flow where API calls can be seen unencrypted.

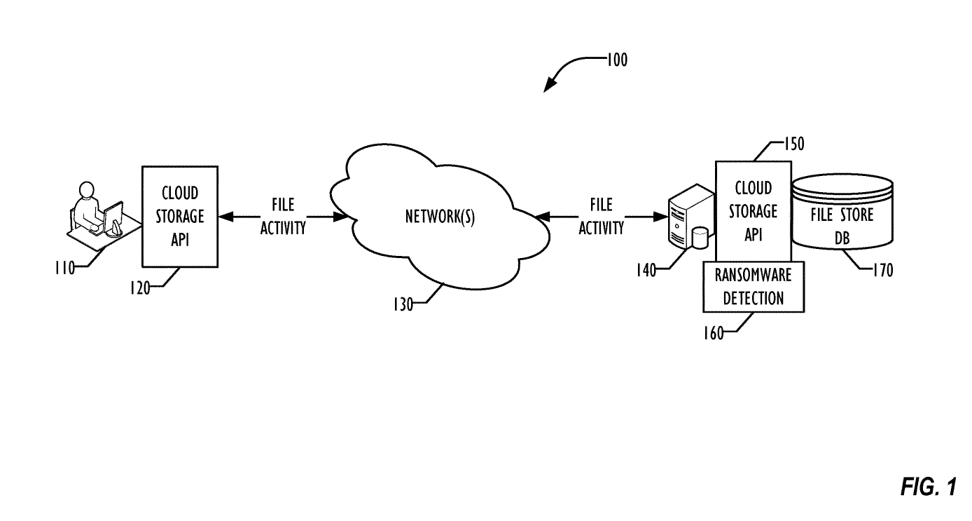

FIG. 1 is a block diagram illustrating a system 100 in which ransomware attacks on local data may be blocked from infecting the user's cloud storage data according to one embodiment. A user at workstation 110 has an account with a cloud storage service. Although illustrated in FIG. 1 as a desktop computer, the user's device may be any type of programmable device that may access cloud storage, including mobile devices such as mobile phones and tablets, desktop computers, and laptop computers. A single user and workstation 110 is illustrated in FIG. 1 for clarity, but cloud storage providers typically have millions of subscribers to the cloud storage service, any of which could have the local workstation be infected by ransomware. Typically, the cloud storage is mapped as a local disk on the workstation 110, allowing the user to interact with the cloud storage as if it were local. However, in some embodiments, the remote storage may be a document management system, typically one made available on an enterprise level.

A cloud storage API 120 installed on the user workstation 110 provides the interface to allow reading, writing, creating, and deleting of files in the cloud storage system. File activity typically traverses one or more networks 130, which may be any number of interconnected networks of any type, to reach a cloud storage server 140. The cloud storage server 140 uses its own cloud storage API to store user file data in a file store database 170. Although a single cloud storage server 140 and file store database 170 are illustrated in FIG. 1 for clarity, one of skill in the art will understand that numerous servers 140 and databases 170 are typically used by a cloud storage provider to implement the cloud storage functionality.

Different cloud services may implement the techniques differently based on the exact API calls used to service users, their location, naming conventions, parameters, etc. One type of API interface that allows user file activity to traverse the network(s) 130 may be the Web Distributed Authoring and Versioning (WebDAV) extensions to the Hypertext Transfer Protocol (HTTP) that allows clients to perform remote web content operations. WebDAV is defined by the Internet Engineering Task Force in RFC 4918.

As described below, a ransomware detection module 160 may interact with the cloud storage API 150 to intercept user file activity, detect and prevent possible ransomware attacks, and offer remediation to the user. In some embodiments, the ransomware detection module 160 hooks into the cloud storage API 150 on the cloud storage server 140, using any desired hooking technique. Any other technique for allowing the ransomware detection module 160 to interact with the cloud storage API 150 may be used.

In some embodiments, a ransomware detection agent (not shown in FIG. 1) may be present on user workstation 110 to obtain context in addition to the ransomware detection module 160 within the cloud service provider's infrastructure. Regardless, the focus is on performing anomaly detection on traffic generated by API interaction with the cloud service instead of file I/O.

Typically cloud service providers provide online cloud storage by storing user data as entries in a database, not as typical files in a filesystem. Few, if any, cloud storage providers use an actual filesystem for storing user data. Therefore, traditional filesystem filter mechanism are inappropriate to the task of protecting cloud storage systems, thus the novel approach of performing analytics to detect anomalous activity is inserted into the cloud storage API 150 itself, not at the OS file system level.

The ransomware detection module 160 filters cloud storage API 150 calls to track modification to existing data structures (which represent user stored files) within the cloud storage system. This monitors for behavior indicating ransomwarelike activity at an API level. The approach is statistical, looking at sequences of events, rather than basing decisions on individual events. For example, a sequence of API calls that have a 1:1 delete and create ratio or similarly sized data objects may indicate the replacement of existing user data structures with new data, such as when ransomware might replace photos with encrypted versions of the photos. More than one sequence of this type may be used by different ransomware: (a) Read A, write B of same size, delete A; (b) Read A, write A with full overwrite; or (c) Read A, B, C, D, . . . , write A1, B1, C1, D1, . . . , delete A, B, C, D, . . . . Other read, write, delete sequences may be used that indicate a ransomware delete and create sequence.

Another sequence of API calls that may by indicative of ransomware comprises deleting of existing data, and creation of new data with near-matching names tags, For example, deletion of test.txt and creation of test.txt.encrypted may be an indication of ransomware on the user workstation 110.

In another embodiment, the ransomware detection module 160 may monitor for behavior indicating ransomware by examining the data accompanying an API call and comparing it to the current data stored for an entry. The following are examples of behavior that may suggest ransomware:

(a) Overwriting existing data with significantly different content, such as a highly different hash map. Most updates to cloud services are partial file writes, not complete same-name data replacement).

(b) Overwriting existing low entropy data with high entropy data, which may indicate encryption of unencrypted user “files.”

As indicated above, some embodiments may optionally augment the data collection by installing an agent on the endpoint device 110 to obtain user context. For example, the agent may:

(a) Determine whether the communication with the cloud API 120 is related to local files, or direct cloud API interaction;

(b) Determine whether the cloud API 120 calls originate from the local machine or from elsewhere, which may indicate a cloud storage account credential compromise;

(c) Act as a mechanism to alert the user of activity and seek instruction as to whether to allow/block the activity; or

(d) Offer the user of workstation 110 an opportunity to recover files potentially corrupted by the ransomware activity.

The ransomware detection module 160 may employ monitoring rules for filtering read, delete, write sequences, as well as delete, write sequences, to identify situations where the activity is due to replication of local files, or is the result of direct manipulation of the cloud storage API.

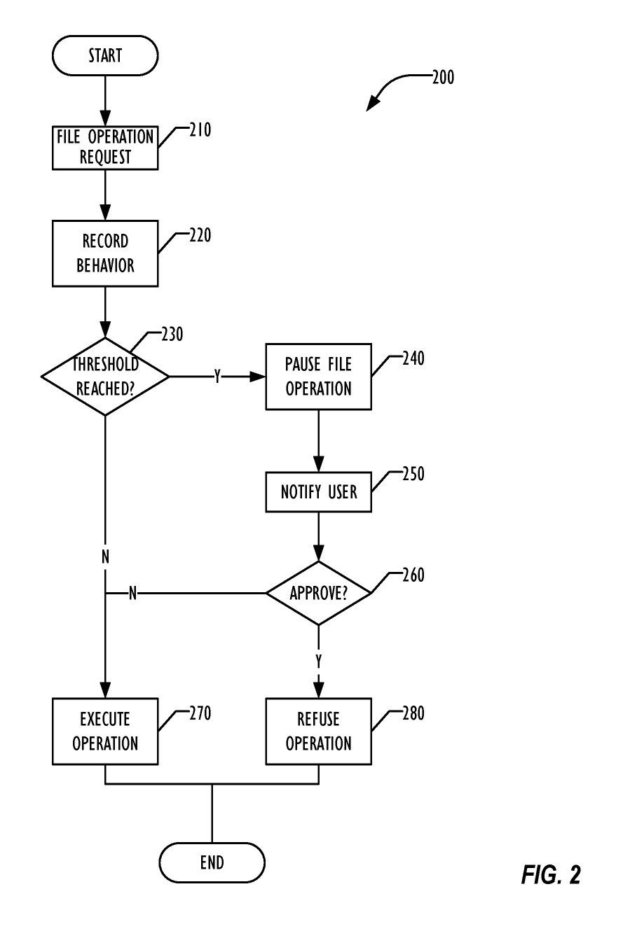

FIG. 2 is a flowchart 200 illustrating a technique for detecting ransomware activity according to one embodiment. In block 210, file operation requests made by the user workstation 110 are detected and analyzed. Because ransomware file operations are individually ordinary file operations, any one specific file operation is generally not recognizable as an indication of ransomware activity. Thus in block 220 the behavior is recorded to allow detection of sequences of actions that together may indicate ransomware activity, such as the sequences described above.

In addition, even a sequence of activity in isolation such as a single read and write of a file with different data may not indicate ransomware activity. Therefore, to avoid false positive detections, embodiments may use a heuristic approach that recognize multiple sequences of activity as an indication of ransomware activity. For example, an embodiment may define a threshold number of events in a time period as an indication of ransomware activity. In another example, an embodiment may define a threshold number of files acted upon in a time period as an indication of ransomware activity, so that reading and writing one file in a directory may not indicate ransomware activity, but reading and writing every file in a directory in a short period of time may. Embodiments may use configurable rules or any other desired technique to indicate the thresholds and other heuristics that are to be used to discover ransomware activity. These rules may be modified from time to time as more information about ransomware behavior is recognized.

In block 230, if a threshold value for ransomware is reached or any other rule indicating ransomware is triggered, then in block 240 the ransomware detection module 160 may cause the cloud storage server 140 to disable performing file activity for the user workstation 110. Until that time, file operations may proceed without interruption. The disablement instituted in block 240 may be configured as desired. For example, the disablement may be a temporary pause for a predetermined time before automatically re-enabling file operations, or may lock the user's cloud storage account until a positive action by the user is performed, such as a re-login. Other ways to pause, slow down, or disable file activity may be instituted as desired.

If desired, upon disabling file activity in block 240, the user may be notified of the action in block 250 and offered a chance in block 260 to approve or disapprove the possibly malicious activity. If approved, then the file operation may continue in block 270, and if disapproved, the file operation may be refused in block 280. Additional user-directed actions or system-directed actions may also be required at this time, such as requiring the user to change a password or other authentication credential before allowing continued file activity.

In some embodiments, the user may not be given an opportunity to approve or disapprove the activity, but the cloud storage server 140 may simply execute or refuse the operation that last triggered the concern as indicating possible ransomware. An indication of the refusal may be provided back to the user as an error in the request as desired.

In some embodiments, the ransomware detection module 160 may learn and update its rules or heuristics based on the user's response to notification. For example, if the user always approves read, delete, write sequences of some number greater than the current threshold, the ransomware detection module 160 may choose to increase the threshold value that triggers a possible refusal of the file operation. Other changes may be made based upon machine learning techniques and analysis of user responses to notifications. In another example, the user may indicate that no request for approval or disapproval is desired, and that the ransomware detection module should always trigger refusal of an operation if the threshold is reached or other rule or heuristic is triggered. Where an agent is included on the endpoint user workstation 110, context information from the agent may be used to adjust the behavior, possibly eliminating additional false positive or even false negatives.

Because the file operations are recorded in block 220, detailed information may be available for all file operations that were considered prior to whatever caused the recognition that a ransomware event was occurring. In some embodiments, that information may be used to automatically roll back the changes that have been made or recover the information from backups, without requiring the user to specify which files need attention. In another embodiment, instead of an automatic roll back, the system 100 may offer the user a list of files to be recovered and request confirmation of which files should be rolled back or recovered. Other recovery techniques may be used. For example, the cloud storage server 140 may flag files involved in the event to be preserved specially to allow the user a longer time than usual to recover earlier versions of files that may have been encrypted by the ransomware.

When ransomware activity is discovered, the cloud service may revert to a blocked mode, preventing further activity, until the user has authorized the activity through some unique authentication, such as may be their cloud login credentials. Any type of authentication to allow renewed file activity may be used. In some embodiments, the ransomware detection module 160 may offer recovery of previous versions of recently changed files, may offer the user the ability to “revert” to a certain point of time for the changed files, or other such recovery mechanisms.

Since this filter is applied within the cloud service logic, infections on unprotected devices, regardless of the type of endpoint (traditional PC, tablet, smartphone etc.) are supported, as well as the case where the cloud service is compromised through account details theft.

The techniques described above provide improvements over existing cloud storage solutions. For example, because cloud storage systems current cannot recognize ransomware attacks on the files maintained by the cloud storage system, after-the-fact recovery is limited to restoration of files from backups and versioning. In many cases, no recovery is available, because no detection is made until sometime after the ransomware has encrypted the files stored by the cloud service provider. By detecting ransomware activity as it is happening, the cloud storage system can apply immediate blocks to prevent further malicious activity, and may have a better opportunity to roll back the effects of the ransomware activity.

Current recovery often relies on users choosing on a file by file basis to recover prior versions. By detecting the ransomware activity as it occurs, prevention of damage can be minimized to the period before the sampling identifies the activity, and may be able to identify the set of files which may have been affected by the ransomware activity.

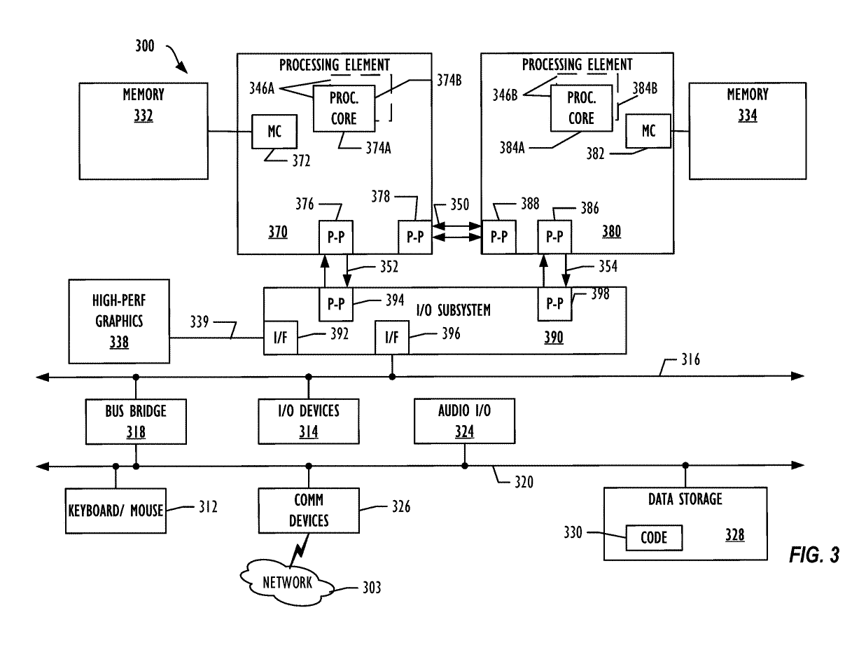

Referring now to FIG. 3, a block diagram illustrates a programmable device 300 that may be used for implementing the techniques described herein in accordance with one embodiment. The programmable device 300 illustrated in FIG. 3 is a multiprocessor programmable device that includes a first processing element 370 and a second processing element 380. While two processing elements 370 and 380 are shown, an embodiment of programmable device 300 may also include only one such processing element.

Programmable device 300 is illustrated as a point-to-point interconnect system, in which the first processing element 370 and second processing element 380 are coupled via a point-to-point interconnect 350. Any or all of the interconnects illustrated in FIG. 3 may be implemented as a multi-drop bus rather than point-to-point interconnects.

As illustrated in FIG. 3, each of processing elements 370 and 380 may be multicore processors, including first and second processor cores (i.e., processor cores 374a and 374b and processor cores 384a and 384b). Such cores 374a, 374b, 384a, 384b may be configured to execute instruction code. However, other embodiments may use processing elements that are single core processors as desired. In embodiments with multiple processing elements 370, 380, each processing element may be implemented with different numbers of cores as desired.

Each processing element 370, 380 may include at least one shared cache 346. The shared cache 346a, 346b may store data (e.g., instructions) that are utilized by one or more components of the processing element, such as the cores 374a, 374b and 384a, 384b, respectively. For example, the shared cache may locally cache data stored in a memory 332, 334 for faster access by components of the processing elements 370, 380. In one or more embodiments, the shared cache 346a, 346b may include one or more mid-level caches, such as level 2 (L2), level 3 (L3), level 4 (L4), or other levels of cache, a last level cache (LLC), or combinations thereof.

While FIG. 3 illustrates a programmable device with two processing elements 370, 380 for clarity of the drawing, the scope of the present invention is not so limited and any number of processing elements may be present. Alternatively, one or more of processing elements 370, 380 may be an element other than a processor, such as an graphics processing unit (GPU), a digital signal processing (DSP) unit, a field programmable gate array, or any other programmable processing element. Processing element 380 may be heterogeneous or asymmetric to processing element 370. There may be a variety of differences between processing elements 370, 380 in terms of a spectrum of metrics of merit including architectural, microarchitectural, thermal, power consumption characteristics, and the like. These differences may effectively manifest themselves as asymmetry and heterogeneity amongst processing elements 370, 380. In some embodiments, the various processing elements 370, 380 may reside in the same die package.

First processing element 370 may further include memory controller logic (MC) 372 and point-to-point (P-P) interconnects 376 and 378. Similarly, second processing element 380 may include a MC 382 and P-P interconnects 386 and 388. As illustrated in FIG. 3, MCs 372 and 382 couple processing elements 370, 380 to respective memories, namely a memory 332 and a memory 334, which may be portions of main memory locally attached to the respective processors. While MC logic 372 and 382 is illustrated as integrated into processing elements 370, 380, in some embodiments the memory controller logic may be discrete logic outside processing elements 370, 380 rather than integrated therein.

Processing element 370 and processing element 380 may be coupled to an I/O subsystem 390 via respective P-P interconnects 376 and 386 through links 352 and 354. As illustrated in FIG. 3, I/O subsystem 390 includes P-P interconnects 394 and 398. Furthermore, I/O subsystem 390 includes an interface 392 to couple I/O subsystem 390 with a high performance graphics engine 338. In one embodiment, a bus (not shown) may be used to couple graphics engine 338 to I/O subsystem 390. Alternately, a point-to-point interconnect 339 may couple these components.

In turn, I/O subsystem 390 may be coupled to a first link 316 via an interface 396. In one embodiment, first link 316 may be a Peripheral Component Interconnect (PCI) bus, or a bus such as a PCI Express bus or another I/O interconnect bus, although the scope of the present invention is not so limited.

As illustrated in FIG. 3, various I/O devices 314, 324 may be coupled to first link 316, along with a bridge 318 that may couple first link 316 to a second link 320. In one embodiment, second link 320 may be a low pin count (LPC) bus. Various devices may be coupled to second link 320 including, for example, a keyboard/mouse 312, communication device(s) 326 (which may in turn be in communication with the computer network 303), and a data storage unit 328 such as a disk drive or other mass storage device which may include code 330, in one embodiment. The code 330 may include instructions for performing embodiments of one or more of the techniques described above. Further, an audio I/O 324 may be coupled to second link 320.

Note that other embodiments are contemplated. For example, instead of the point-to-point architecture of FIG. 3, a system may implement a multi-drop bus or another such communication topology. Although links 316 and 320 are illustrated as busses in FIG. 3, any desired type of link may be used. In addition, the elements of FIG. 3 may alternatively be partitioned using more or fewer integrated chips than illustrated in FIG. 3.

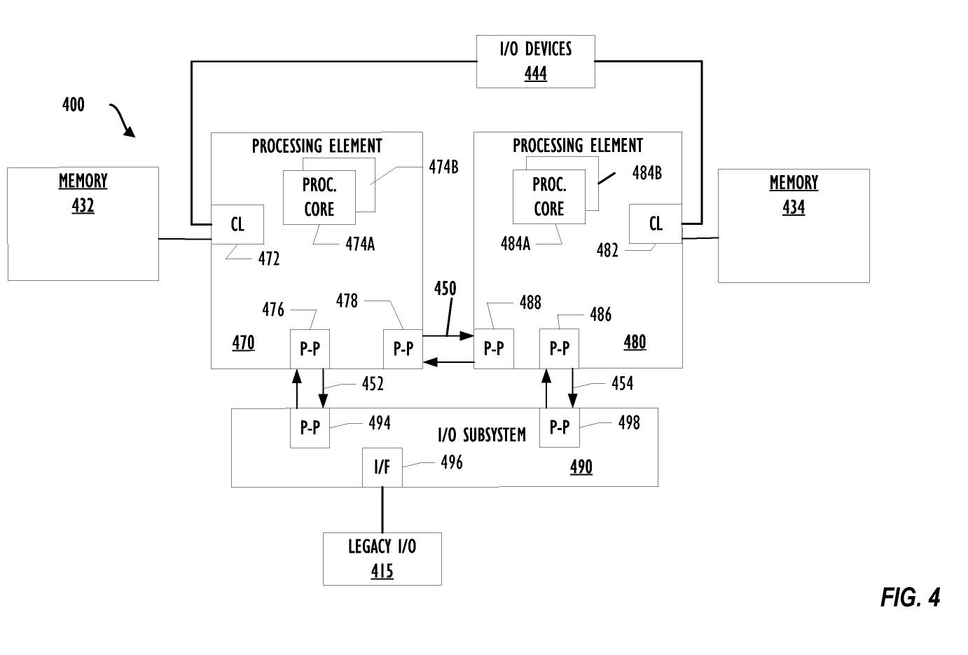

Referring now to FIG. 4, a block diagram illustrates a programmable device 400 according to another embodiment. Certain aspects of FIG. 4 have been omitted from FIG. 4 in order to avoid obscuring other aspects of FIG. 4.

FIG. 4 illustrates that processing elements 470, 480 may include integrated memory and I/O control logic (“CL”) 472 and 482, respectively. In some embodiments, the 472, 482 may include memory control logic (MC) such as that described above in connection with FIG. 3. In addition, CL 472, 482 may also include I/O control logic. FIG. 4 illustrates that not only may the memories 432, 434 be coupled to the CL 472, 482, but also that I/O devices 444 may also be coupled to the control logic 472, 482. Legacy I/O devices 415 may be coupled to the I/O subsystem 490 by interface 496. Each processing element 470, 480 may include multiple processor cores, illustrated in FIG. 4 as processor cores 474A, 474B, 484A and 484B. As illustrated in FIG. 4, I/O subsystem 490 includes point-to-point (P-P) interconnects 494 and 498 that connect to P-P interconnects 476 and 486 of the processing elements 470 and 480 with links 452 and 454. Processing elements 470 and 480 may also be interconnected by link 450 and interconnects 478 and 488, respectively.

The programmable devices depicted in FIGS. 3 and 4 are schematic illustrations of embodiments of programmable devices that may be utilized to implement various embodiments discussed herein. Various components of the programmable devices depicted in FIGS. 3 and 4 may be combined in a system-on-a-chip (SoC) architecture.

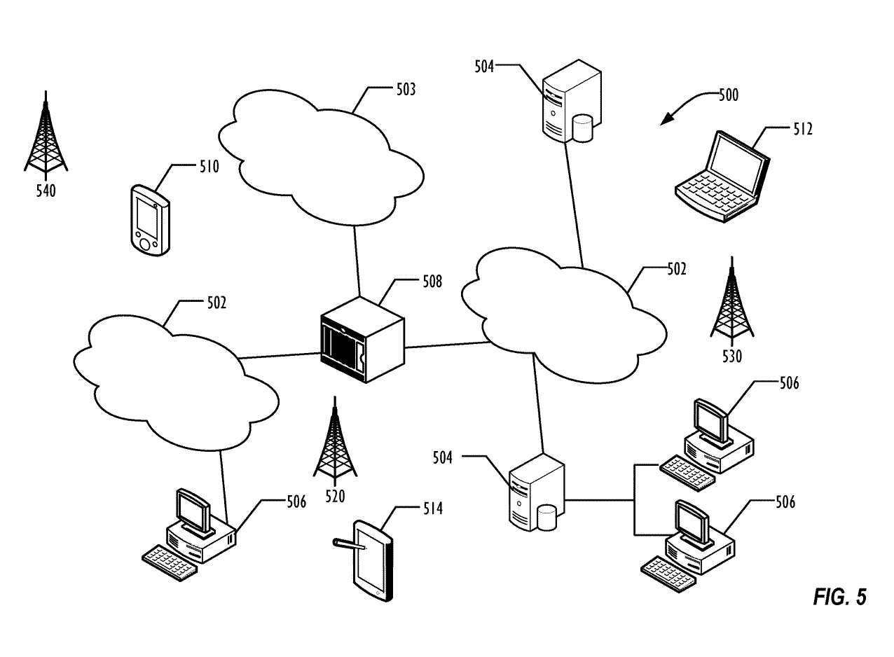

Referring now to FIG. 5, an example infrastructure 500 in which the techniques described above may be implemented is illustrated schematically. Infrastructure 500 contains computer networks 502. Computer networks 502 may include many different types of computer networks available today, such as the Internet, a corporate network or a Local Area Network (LAN). Each of these networks can contain wired or wireless programmable devices and operate using any number of network protocols (e.g., TCP/IP). Networks 502 may be connected to gateways and routers (represented by 508), end user computers 506, and computer servers 504.

Infrastructure 500 also includes cellular network 503 for use with mobile communication devices. Mobile cellular networks support mobile phones and many other types of mobile devices. Mobile devices in the infrastructure 500 are illustrated as mobile phones 510, laptops 512 and tablets 514. A mobile device such as mobile phone 510 may interact with one or more mobile provider networks as the mobile device moves, typically interacting with a plurality of mobile network towers 520, 530, and 540 for connecting to the cellular network 503. Although referred to as a cellular network in FIG. 5, a mobile device may interact with towers of more than one provider network, as well as with multiple non-cellular devices such as wireless access points and routers 508. In addition, the mobile devices 510, 512 and 514 may interact with non-mobile devices such as computers 504 and 506 for desired services

The servers 504 in this scenario represent cloud storage service providers, allowing endpoint devices such as the end user computers 506 and mobile devices 510, 512 and 514 to store files in the cloud storage servers 504 safely, with less risk that files stored by the cloud storage servers 504 may be encrypted by ransomware attacks on the end user computers 506 and mobile devices 510, 512 and 514.

Embodiments may be implemented in one or a combination of hardware, firmware, and software. Embodiments may also be implemented as instructions stored on a computer-readable storage medium, which may be read and executed by at least one processing element to perform the operations described herein. A computer-readable storage medium may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

Embodiments, as described herein, may include, or may operate on, logic or a number of components, modules, or mechanisms. Modules may be hardware, software, or firmware communicatively coupled to one or more processing elements in order to carry out the operations described herein. Modules may be hardware modules, and as such, modules may be considered tangible entities capable of performing specified operations and may be configured or arranged in a certain manner. Circuits may be arranged (e.g., internally or with respect to external entities such as other circuits) in a specified manner as a module. The whole or part of one or more programmable devices (e.g., a standalone client or server computer system) or one or more hardware processing elements may be configured by firmware or software (e.g., instructions, an application portion, or an application) as a module that operates to perform specified operations. The software may reside on a computer readable medium. The software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Where modules are temporarily configured, each of the modules need not be instantiated at any one moment in time. For example, where the modules comprise a general-purpose hardware processing element configured using software; the general-purpose hardware processing element may be configured as respective different modules at different times. Software may accordingly program a hardware processor, for example, to constitute a particular module at one instance of time and to constitute a different module at a different instance of time. Modules may also be software or firmware modules, which operate to perform the methodologies described herein.

The following examples pertain to further embodiments.

Example 1 is a computer readable medium storing software for improving protection against ransomware by a cloud storage system, comprising instructions that when executed cause a cloud storage server to: hook into a cloud storage server application programming interface; intercept cloud storage operations requested by an endpoint device; record the requested cloud storage operations; analyze the recorded cloud storage operations to determine whether ransomware activity is occurring; and block ransomware activity on the cloud storage server responsive to the analysis.

In Example 2 the subject matter of Example 1 optionally includes wherein the instructions that when executed cause the cloud storage server to block ransomware activity comprise instructions that when executed cause the cloud storage server to: block cloud storage operations requested by a user of the endpoint device.

In Example 3 the subject matter of Example 1 optionally includes wherein the instructions that when executed cause the cloud storage server to block ransomware activity comprise instructions that when executed cause the cloud storage server to: notify a user of the endpoint device of possible ransomware activity; receive instructions from the user on whether to allow the cloud storage operations; and block the cloud storage operations responsive to the instructions.

In Example 4 the subject matter of any of Examples 1-3 optionally includes wherein the instructions that when executed cause the cloud storage server to analyze the requested cloud storage operations comprise instructions that when executed cause the cloud storage server to: identify a plurality of sequences of cloud storage operations in the recorded cloud storage operations that may indicate ransomware activity.

In Example 5 the subject matter of Example 4 optionally includes wherein the instructions that when executed cause the cloud storage server to analyze the requested cloud storage operations further comprise instructions that when executed cause the cloud storage server to: compare the plurality of sequences of cloud storage operations in the recorded cloud storage operations with a predetermined threshold value; and determine whether ransomware activity is occurring responsive to the comparison.

In Example 6 the subject matter of Example 4 optionally includes wherein the sequences of cloud storage operations comprise sequences of cloud storage operations that indicate replacement of existing data with new data.

In Example 7 the subject matter of Example 4 optionally includes wherein the sequences of cloud storage operations comprise sequences of cloud storage operations that delete existing data and create new data with near-matching names.

In Example 8 the subject matter of any of Examples 1-3 optionally includes wherein the instructions further comprise instructions that when executed cause the cloud storage server to: receive cloud storage context information from an agent on the endpoint device requesting the cloud storage operations; and consider the cloud storage context information when analyzing the recorded cloud storage operations.

Example 9 is a method of improving ransomware protection in cloud storage systems, comprising: intercepting application programming interface calls for cloud storage operations at a cloud storage server; recording cloud storage operations requested by an endpoint device; analyzing the recorded cloud storage operations; determining whether ransomware activity is indicated by the recorded cloud storage operations; and blocking ransomware activity on the cloud storage server responsive to the determination.

In Example 10 the subject matter of Example 9 optionally includes wherein blocking ransomware activity comprises: pausing the cloud storage operations; notifying a user of the endpoint device of possible ransomware activity; and rejecting the cloud storage operations responsive to instructions received from the user.

In Example 11 the subject matter of Example 9 optionally includes wherein blocking ransomware activity comprises: blocking cloud storage operations; and unblocking cloud storage operations responsive to reauthentication of a user of the endpoint device.

In Example 12 the subject matter of any of Examples 9-11 optionally includes wherein analyzing the recorded cloud storage operations comprises: identifying a plurality of sequences of cloud storage operations in the recorded cloud storage operations that may indicate ransomware activity.

In Example 13 the subject matter of Example 12 optionally includes wherein analyzing the recorded cloud storage operations further comprises: comparing the plurality of sequences of cloud storage operations with a predetermined threshold value; and wherein determining whether ransomware activity is indicated by the recorded cloud storage operations comprises: determining whether the plurality of sequences of cloud storage operations indicates ransomware activity responsive to the comparison.

In Example 14 the subject matter of Example 12 optionally includes wherein the plurality of sequences of cloud storage operations comprises a plurality of sequences of cloud storage operations replacing existing data with new data.

In Example 15 the subject matter of Example 12 optionally includes wherein the plurality of sequences of cloud storage operations comprises a plurality of sequences of cloud storage operations that delete existing data and create new data with near matching names.

In Example 16 the subject matter of any of Examples 9-11 optionally includes wherein analyzing the recorded cloud storage operations comprises: receiving context information related to the recorded cloud storage operations from an agent on the endpoint device.

In Example 17 the subject matter of Example 16 optionally includes wherein the context information indicates the cloud storage operations originated remote to the endpoint device.

Example 18 is a cloud storage server programmed to block ransomware activity, comprising: a processing element; a memory, coupled to the processing element, on which is stored improved anti-ransomware protection software comprising instructions that when executed program the processing element to: hook into a cloud storage server application programming interface; intercept cloud storage operations requested by an endpoint device; record the requested cloud storage operations; analyze the recorded cloud storage operations to determine whether ransomware activity is occurring; and block ransomware activity responsive to the analysis.

In Example 19 the subject matter of Example 18 optionally includes wherein the instructions that when executed program the processing element to block ransomware activity comprise instructions that when executed program the processing element to: block cloud storage operations requested by a user of the endpoint device.

In Example 20 the subject matter of Example 18 optionally includes wherein the instructions that when executed program the processing element to block ransomware activity comprise instructions that when executed program the processing element to: notify a user of the endpoint device of possible ransomware activity; receive instructions from the user on whether to allow the cloud storage operations; and block the cloud storage operations responsive to the instructions.

In Example 21 the subject matter of any of Examples 18-20 optionally includes wherein the instructions that when executed program the processing element to analyze the requested cloud storage operations comprise instructions that when executed program the processing element to: identify a plurality of sequences of cloud storage operations in the recorded cloud storage operations that may indicate ransomware activity.

In Example 22 the subject matter of Example 21 optionally includes wherein the instructions that when executed program the processing element to analyze the requested cloud storage operations further comprise instructions that when executed program the processing element to: compare the plurality of sequences of cloud storage operations in the recorded cloud storage operations with a predetermined threshold value; and determine whether ransomware activity is occurring responsive to the comparison.

In Example 23 the subject matter of Example 21 optionally includes wherein the sequences of cloud storage operations comprise sequences of cloud storage operations that indicate replacement of existing data with new data.

In Example 24 the subject matter of Example 21 optionally includes wherein the sequences of cloud storage operations comprise sequences of cloud storage operations that delete existing data and create new data with near-matching names.

In Example 25 the subject matter of any of Examples 18-20 optionally includes wherein the instructions further comprise instructions that when executed program the processing element to: receive cloud storage context information from an agent on the endpoint device requesting the cloud storage operations; and consider the cloud storage context information when analyzing the recorded cloud storage operations.

Example 26 is an apparatus for improving protection against ransomware by a cloud storage system, comprising: means for hooking into a cloud storage server application programming interface; means for intercepting cloud storage operations requested by an endpoint device; means for recording the requested cloud storage operations; means for analyzing the recorded cloud storage operations to determine whether ransomware activity is occurring; and means for blocking ransomware activity on the cloud storage server responsive to the analysis.

In Example 27 the subject matter of Example 26 optionally includes wherein the means for blocking ransomware activity comprise means for blocking cloud storage operations requested by a user of the endpoint device.

In Example 28 the subject matter of Example 26 optionally includes wherein the means for blocking ransomware activity comprise: means for notifying a user of the endpoint device of possible ransomware activity; means for receiving instructions from the user on whether to allow the cloud storage operations; and means for blocking the cloud storage operations responsive to the instructions.

In Example 29 the subject matter of any of Examples 26-28 optionally includes wherein the means for analyzing the requested cloud storage operations comprise: means for identifying a plurality of sequences of cloud storage operations in the recorded cloud storage operations that may indicate ransomware activity.

In Example 30 the subject matter of Example 29 optionally includes wherein the means for analyzing the requested cloud storage operations further comprise: means for comparing the plurality of sequences of cloud storage operations in the recorded cloud storage operations with a predetermined threshold value; and means for determining whether ransomware activity is occurring responsive to the comparison.

In Example 31 the subject matter of Example 29 optionally includes wherein the sequences of cloud storage operations comprise sequences of cloud storage operations that indicate replacement of existing data with new data.

In Example 32 the subject matter of Example 29 optionally includes wherein the sequences of cloud storage operations comprise sequences of cloud storage operations that delete existing data and create new data with near-matching names.

In Example 33 the subject matter of any of Examples 26-28 optionally includes further comprising: means for receiving cloud storage context information from an agent on the endpoint device requesting the cloud storage operations; and means for considering the cloud storage context information when analyzing the recorded cloud storage operations.

Example 34 is a computer readable medium storing software for improving protection against ransomware by a cloud storage system, comprising instructions that when executed cause a cloud storage server to: hook into a cloud storage server application programming interface; intercept cloud storage operations requested by an endpoint device; record the requested cloud storage operations; analyze the recorded cloud storage operations to determine whether ransomware activity is occurring; and block ransomware activity on the cloud storage server responsive to the analysis, wherein the ransomware activity comprises cloud storage operations requested by user of the endpoint device.

In Example 35 the subject matter of Example 34 optionally includes wherein the instructions that when executed cause the cloud storage server to block ransomware activity comprise instructions that when executed cause the cloud storage server to: notify a user of the endpoint device of possible ransomware activity; receive instructions from the user on whether to allow the cloud storage operations; and block the cloud storage operations responsive to the instructions.

In Example 36 the subject matter of any of Examples 34-35 optionally includes wherein the instructions that when executed cause the cloud storage server to analyze the requested cloud storage operations comprise instructions that when executed cause the cloud storage server to: identify a plurality of sequences of cloud storage operations in the recorded cloud storage operations that may indicate ransomware activity.

In Example 37 the subject matter of Example 36 optionally includes wherein the instructions that when executed cause the cloud storage server to analyze the requested cloud storage operations further comprise instructions that when executed cause the cloud storage server to: compare the plurality of sequences of cloud storage operations in the recorded cloud storage operations with a predetermined threshold value; and determine whether ransomware activity is occurring responsive to the comparison.

In Example 38 the subject matter of any of Examples 34-35 optionally includes wherein the instructions further comprise instructions that when executed cause the cloud storage server to: receive cloud storage context information from an agent on the endpoint device requesting the cloud storage operations; and consider the cloud storage context information when analyzing the recorded cloud storage operations.

Example 39 is a method of improving ransomware protection in cloud storage systems, comprising: intercepting application programming interface calls for cloud storage operations at a cloud storage server; recording cloud storage operations requested by an endpoint device; analyzing the recorded cloud storage operations; determining whether ransomware activity is indicated by the recorded cloud storage operations; and blocking ransomware activity on the cloud storage server responsive to the determination.

In Example 40 the subject matter of Example 39 optionally includes wherein blocking ransomware activity comprises: pausing the cloud storage operations; notifying a user of the endpoint device of possible ransomware activity; and rejecting the cloud storage operations responsive to instructions received from the user.

In Example 41 the subject matter of Example 39 optionally includes wherein blocking ransomware activity comprises: blocking cloud storage operations; and unblocking cloud storage operations responsive to reauthentication of a user of the endpoint device.

In Example 42 the subject matter of any of Examples 39-40 optionally includes wherein analyzing the recorded cloud storage operations comprises: identifying a plurality of sequences of cloud storage operations in the recorded cloud storage operations that may indicate ransomware activity; and comparing the plurality of sequences of cloud storage operations with a predetermined threshold value; and wherein determining whether ransomware activity is indicated by the recorded cloud storage operations comprises: determining whether the plurality of sequences of cloud storage operations indicates ransomware activity responsive to the comparison.

In Example 43 the subject matter of any of Examples 39-40 optionally includes wherein analyzing the recorded cloud storage operations comprises: receiving context information related to the recorded cloud storage operations from an agent on the endpoint device.

Example 44 is a cloud storage server programmed to block ransomware activity, comprising: a processing element; a memory, coupled to the processing element, on which is stored improved anti-ransomware protection software comprising instructions that when executed program the processing element to: hook into a cloud storage server application programming interface; intercept cloud storage operations requested by an endpoint device; record the requested cloud storage operations; analyze the recorded cloud storage operations to determine whether ransomware activity is occurring; and block ransomware activity responsive to the analysis, wherein the ransomware activity comprises cloud storage operations requested by a user of the endpoint device.

In Example 45 the subject matter of Example 44 optionally includes wherein the instructions that when executed program the processing element to block ransomware activity comprise instructions that when executed program the processing element to: notify a user of the endpoint device of possible ransomware activity; receive instructions from the user on whether to allow the cloud storage operations; and block the cloud storage operations responsive to the instructions.

In Example 46 the subject matter of any of Examples 44-45 optionally includes wherein the instructions that when executed program the processing element to analyze the requested cloud storage operations comprise instructions that when executed program the processing element to: identify a plurality of sequences of cloud storage operations in the recorded cloud storage operations that may indicate ransomware activity.

In Example 47 the subject matter of Example 46 optionally includes wherein the instructions that when executed program the processing element to analyze the requested cloud storage operations further comprise instructions that when executed program the processing element to: compare the plurality of sequences of cloud storage operations in the recorded cloud storage operations with a predetermined threshold value; and determine whether ransomware activity is occurring responsive to the comparison.

The cloud storage server of any of claims 44-45, wherein the instructions further comprise instructions that when executed program the processing element to: receive cloud storage context information from an agent on the endpoint device requesting the cloud storage operations; and consider the cloud storage context information when analyzing the recorded cloud storage operations.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

1. A computer readable medium storing software for improving protection against ransomware by a cloud storage system, comprising instructions that when executed cause a cloud storage server to:
hook into a cloud storage server application programming interface;
intercept cloud storage server application programming interface calls for cloud storage operations requested by an endpoint device;
record the requested cloud storage operations;
analyze the recorded cloud storage operations to determine whether ransomware activity is occurring; and
block ransomware activity on the cloud storage server responsive to the analysis.

2. The computer readable medium of claim 1, wherein the instructions that when executed cause the cloud storage server to block ransomware activity comprise instructions that when executed cause the cloud storage server to:
block cloud storage operations requested by a user of the endpoint device.

3. The computer readable medium of claim 1, wherein the instructions that when executed cause the cloud storage server to block ransomware activity comprise instructions that when executed cause the cloud storage server to:
notify a user of the endpoint device of possible ransomware activity;
receive instructions from the user on whether to allow the cloud storage operations; and
block the cloud storage operations responsive to the instructions.

4. The computer readable medium of claim 1, wherein the instructions that when executed cause the cloud storage server to analyze the requested cloud storage operations comprise instructions that when executed cause the cloud storage server to:
identify a plurality of sequences of cloud storage operations in the recorded cloud storage operations that may indicate ransomware activity.

5. The computer readable medium of claim 4, wherein the instructions that when executed cause the cloud storage server to analyze the requested cloud storage operations further comprise instructions that when executed cause the cloud storage server to:
compare the plurality of sequences of cloud storage operations in the recorded cloud storage operations with a predetermined threshold value; and
determine whether ransomware activity is occurring responsive to the comparison.

6. The computer readable medium of claim 4, wherein the sequences of cloud storage operations comprise sequences of cloud storage operations that indicate replacement of existing data with new data.

7. The computer readable medium of claim 4, wherein the sequences of cloud storage operations comprise sequences of cloud storage operations that delete existing data and create new data with near-matching names.

8. The computer readable medium of claim 1, wherein the instructions further comprise instructions that when executed cause the cloud storage server to:
receive cloud storage context information from an agent on the endpoint device requesting the cloud storage operations; and
consider the cloud storage context information when analyzing the recorded cloud storage operations.

9. A method of improving ransomware protection in cloud storage systems, comprising:
intercepting application programming interface calls for cloud storage operations at a cloud storage server;
recording cloud storage operations requested by an endpoint device;
analyzing the recorded cloud storage operations;
determining whether ransomware activity is indicated by the recorded cloud storage operations; and
blocking ransomware activity on the cloud storage server responsive to the determination.

10. The method of claim 9, wherein blocking ransomware activity comprises:
pausing the cloud storage operations;
notifying a user of the endpoint device of possible ransomware activity; and
rejecting the cloud storage operations responsive to instructions received from the user.

11. The method of claim 9, wherein blocking ransomware activity comprises:
blocking cloud storage operations; and
unblocking cloud storage operations responsive to reauthentication of a user of the endpoint device.

12. The method of claim 9, wherein analyzing the recorded cloud storage operations comprises:
identifying a plurality of sequences of cloud storage operations in the recorded cloud storage operations that may indicate ransomware activity.

13. The method of claim 12,
wherein analyzing the recorded cloud storage operations further comprises:
comparing the plurality of sequences of cloud storage operations with a predetermined threshold value; and
wherein determining whether ransomware activity is indicated by the recorded cloud storage operations comprises:
determining whether the plurality of sequences of cloud storage operations indicates ransomware activity responsive to the comparison.

14. The method of claim 12, wherein the plurality of sequences of cloud storage operations comprises a plurality of sequences of cloud storage operations replacing existing data with new data.

15. The method of claim 12, wherein the plurality of sequences of cloud storage operations comprises a plurality of sequences of cloud storage operations that delete existing data and create new data with near matching names.

16. The method of claim 9, wherein analyzing the recorded cloud storage operations comprises:
receiving context information related to the recorded cloud storage operations from an agent on the endpoint device.

17. The method of claim 16, wherein the context information indicates the cloud storage operations originated remote to the endpoint device.

18. A cloud storage server programmed to block ransomware activity, comprising:
a processing element;
a memory, coupled to the processing element, on which is stored improved anti-ransomware protection software comprising instructions that when executed program the processing element to:
hook into a cloud storage server application programming interface;
intercept cloud storage operations requested by an endpoint device;
record the requested cloud storage operations;
analyze the recorded cloud storage operations to determine whether ransomware activity is occurring; and
block ransomware activity responsive to the analysis.

19. The cloud storage server of claim 18, wherein the instructions that when executed program the processing element to block ransomware activity comprise instructions that when executed program the processing element to:
block cloud storage operations requested by a user of the endpoint device.

20. The cloud storage server of claim 18, wherein the instructions that when executed program the processing element to block ransomware activity comprise instructions that when executed program the processing element to:
notify a user of the endpoint device of possible ransomware activity;
receive instructions from the user on whether to allow the cloud storage operations; and
block the cloud storage operations responsive to the instructions.

21. The cloud storage server of claim 18, wherein the instructions that when executed program the processing element to analyze the requested cloud storage operations comprise instructions that when executed program the processing element to:
identify a plurality of sequences of cloud storage operations in the recorded cloud storage operations that may indicate ransomware activity.

22. The cloud storage server of claim 21, wherein the instructions that when executed program the processing element to analyze the requested cloud storage operations further comprise instructions that when executed program the processing element to:
compare the plurality of sequences of cloud storage operations in the recorded cloud storage operations with a predetermined threshold value; and
determine whether ransomware activity is occurring responsive to the comparison.

23. The cloud storage server of claim 21, wherein the sequences of cloud storage operations comprise sequences of cloud storage operations that indicate replacement of existing data with new data.

24. The cloud storage server of claim 21, wherein the sequences of cloud storage operations comprise sequences of cloud storage operations that delete existing data and create new data with near-matching names.

25. The cloud storage server of claim 18, wherein the instructions further comprise instructions that when executed program the processing element to:
receive cloud storage context information from an agent on the endpoint device requesting the cloud storage operations; and
consider the cloud storage context information when analyzing the recorded cloud storage operations.
